(19) United States
(12) Patent Application Publication
(10) Pub. No.: US 2018/0155085 A1
(43) Pub. Date: Jun. 7, 2018

(54) Flat Folded Bottom Self Opening Style Bag and Method of Manufacture

(71) Applicant: Gateway Packaging Company, White House, TN (US)

(72) Inventors: Robert Tiepelman, High Ridge, MO (US); Omar Abuaita, Nashville, TN (US); Brian Schiermeier, Florissant, MO (US)

(73) Assignee: Gateway Packaging Company, White House, TN (US)

(21) Appl. No.: 15/726,782

(22) Filed: Oct. 6, 2017

Related U.S. Application Data
(60) Provisional application No. 62/405,396, filed on Oct. 7, 2016.

(51) Int. Cl. B65D 30/20; B65D 30/08; B65D 30/18; B31B 70/20; B31B 70/26; B31B 70/64

(52) U.S. Cl. CPC B65D 31/10; B65D 31/02; B65D 31/08; B31B 2155/0012; B31B 70/20; B31B 70/26; B31B 70/64; B65D 31/04

(57) ABSTRACT

A method of manufacturing an SOS bag of indefinite length is disclosed including, as a preliminary step, providing a gusseted tube of indefinite length. In a series of steps, the gusseted tube may be cut, trimmed, folded, and sealed to create a unique bottom for an SOS bag. The bottoms of the front panel and the rear panel may be cut so as to permit the inward folding of the bottoms of the gussets of the gusseted tube, such that the bottoms of the gussets overlap. A front panel of the gusseted tube may then undergo a trimming and folding and heat sealing, followed by the rear panel of the gusseted tube undergoing a trimming and folding and heat sealing. The disclosure additionally includes bags manufactured by the method disclosed herein, as well as SOS bags having the unique construction disclosed herein.

### PRIORITY CLAIM

This application claims priority to co-pending U.S. provisional patent application 62/405,396, filed on Oct. 7, 2016.

### FIELD OF DISCLOSURE

A new gusseted self-opening style bag with a unique bottom construction is disclosed, the bag manufactured via a new manufacturing process.

### BACKGROUND

The statements in this section merely provide background information related to the disclosure and do not necessarily all constitute prior art.

The prior art includes a bag known as an SOS bag. Opinions differ on what SOS abbreviates, though it is commonly considered an abbreviation of Self Opening Style. Other interpretations of SOS include Self Opening Sack, Self Opening Square, and Self Opening Satchel. Regardless, an SOS bag as described herein is generally understood to be a gusseted bag including front and back panels joined by gussets, where the bag may be opened from a flat folded orientation to reveal a substantially flat rectangular bottom. When the bag is opened, the gussets may be unfolded and serve as side walls that, in conjunction with the front and back panels of the bag, as well as the rectangular bottom, define the general structure of the bag. A ubiquitous SOS bag of the prior art might include, by way of illustrative example, a simple single-layer brown paper lunch sack.

In the packaging industry, it is common for the top of the SOS bag to be filled with consumer goods, followed by the closure of the top of the bag to contain the goods. This closure can be done in a variety of manners, including applying adhesive or other seal to the top of the bag and rolling the bag closed to complete a top seal of the bag. In other applications, a reclosure apparatus, such as a resealable zipper profile with complementary interlocking features or a hook and loop type reclosure mechanism, for example, may be mounted atop the bag. In other applications, a heat or ultrasonic seal could be applied across the top of the bag.

Rectangular bottom, gusseted bags made substantially of plastic material exist in the art, though those bags are substantially distinct from the bags of this disclosure, specifically in that they are not traditional SOS bags. For example, some rectangular bottom gusseted bags of the prior art, such as those manufactured on box pouch machines, are not made from a gusseted tube. Rather, they are from one or more webs of material that are folded and sealed together into the general shape of a bag. These prior art bags are folded, heat sealed, and then trimmed to give flush edges around the folds and seams of the gussets, side walls, and bottoms, creating substantial waste. One of skill in the art will appreciate the numerous distinctions between a patch-style bag and a bag that will be disclosed herein.

### SUMMARY

This section provides a general summary of the disclosure, and is not intended to provide a comprehensive disclosure of its full scope or all of its features.

This disclosure includes method of manufacturing a new SOS bag including, as a preliminary step, providing a gusseted tube of indefinite length. In a series of steps, the gusseted tube may be cut, trimmed, folded, and sealed to create a unique bottom for an SOS bag. The bottoms of the front panel and the rear panel may be cut so as to permit the inward folding of the bottoms of the gussets of the gusseted tube, such that the bottoms of the gussets overlap. A front panel of the gusseted tube may then undergo a trimming and folding and heat sealing, followed by the rear panel of the gusseted tube undergoing a trimming and folding and heat sealing. Other sealing mechanisms and a variety of bag material constructions are disclosed.

The disclosure additionally includes bags manufactured by the method disclosed herein, as well as SOS bags having the unique construction disclosed herein.

### BRIEF DESCRIPTION OF THE FIGURES

The drawings described herein are for illustrative purposes only of selected embodiments and not all possible implementations, and are not intended to limit the scope of the present disclosure.

FIG. 1, which shows prior art, is a perspective view of a conventional SOS bag, this bag open and resting upright on its bottom.

FIG. 2, which also shows prior art, is a view of the conventional SOS bag of FIG. 1, this particular view showing the bag folded and laying down, with the bottom of the bag visible.

FIG. 3 shows an embodiment of the creation of the gusseted tube of material into which a bag of the disclosure will be made, this figure showing an embodiment of sealing of the overlap of the bag panel.

FIG. 4 shows an embodiment of a gusseted tube of material of an indefinite length.

FIG. 5 shows an embodiment of a die cut layout of an unfolded bag of the disclosure, this layout showing a step cut top.

FIG. 6 shows an embodiment of a die cut layout of an unfolded bag of the disclosure, this layout showing a Z cut top.

FIG. 7A shows a view of the gusseted tube of FIG. 4, including details of cut lines and fold lines on the front panel at the bottom end of the tube, in a step of an embodiment of the bag manufacturing process.

FIG. 7B shows an alternate view of the gusseted tube of FIG. 7A, including details of cut lines and fold lines on the rear panel at the bottom end of the tube, in a step of an embodiment of the bag manufacturing process.

FIG. 8 shows the gusseted tube of FIGS. 7A and 7B, viewed from the bottom, including details of inward folding of the gussets, in a step of an embodiment of the bag manufacturing process, where the gusseted tube is substantially flat.

FIG. 9 shows the configuration and presentation of the gusseted tube of FIG. 8 in a T shape to a sealing apparatus, including details a first sealing region, in a step of an embodiment of the bag manufacturing process.

FIG. 10 shows the trimmed and folded front bottom flap of the gusseted tube of FIG. 9, including details of two additional regions of sealing, in a step of an embodiment of the bag manufacturing process.

FIG. 11 shows the trimmed and folded rear bottom flap of the gusseted tube of FIG. 10, including details of additional heat sealing, in a step of an embodiment of the bag manufacturing process, this final step completing the assembly of the gusseted tube into a bag of the disclosure.

FIG. 12 shows an embodiment of a series of completed bags of the disclosure as displayed on retail shelving for viewing by consumers.

Corresponding reference numerals indicate corresponding parts throughout the several views of the drawings.

### DETAILED DESCRIPTION

The following description of various embodiments is merely exemplary in nature and is in no way intended to limit the invention, its application, or its uses. Areas of applicability will become apparent from the description provided herein.

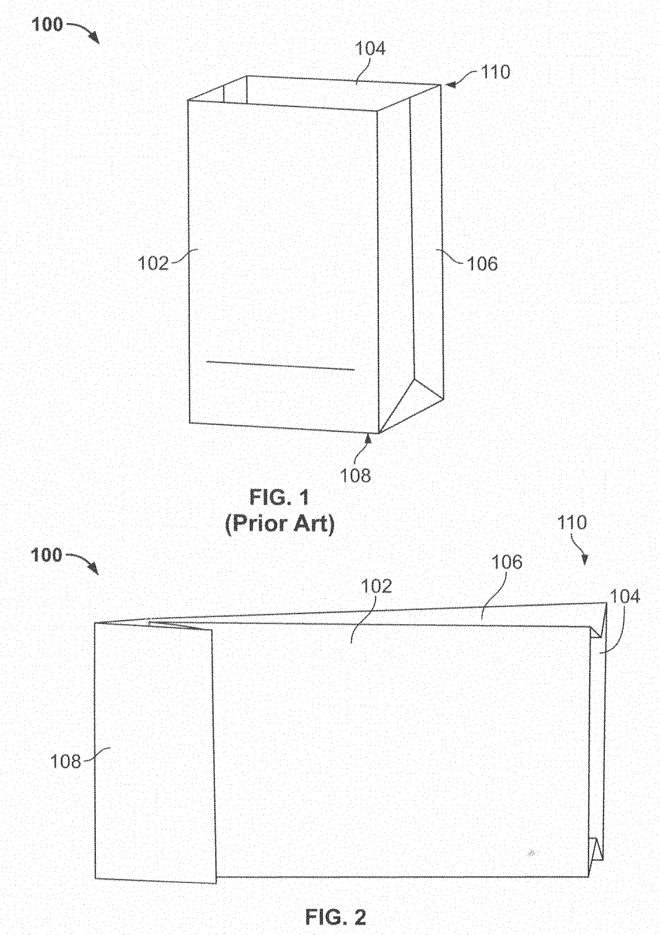

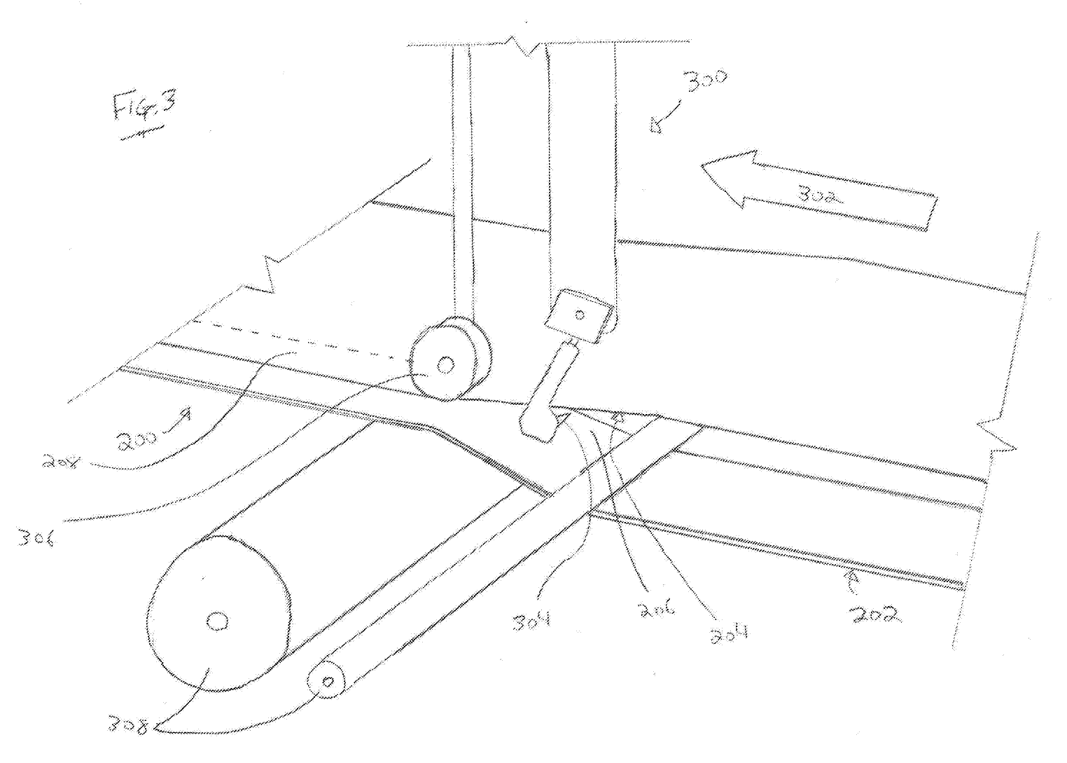

A new SOS bag with a unique bottom closure, as well as a method of making the same, is disclosed. A typical SOS bag 100, as seen in FIG. 1, includes a front panel 102, a back panel 104, and two gusseted side panels 106 joining the front and back panels, to create a tube having an inside and an outside. A length of tube may be folded and sealed at one end to create a bottom 108, thereby forming an SOS bag. The unfolded, open end of the tube may be referred to as the top 110 of the bag or the open end of the bag. The SOS bag of FIG. 1 is unfolded and opened upright, while the SOS bag of FIG. 2 is folded substantially flat. A bag of the disclosure will resemble the prior art SOS bag of FIGS. 1 and 2, with the distinction that the bottom of the bag of the disclosure includes a unique construction manufactured via a unique method, as will now be explained.

A bag of the disclosure may be constructed from a gusseted tube of material of indefinite length.

The tube, and hence the bag, may be constructed of a variety of materials, including but not limited to a multi-layer construction. A multi-layer construction, for example, may include plastic film on the inner-most layer on the inside of the bag. Other layers may include printed paper, such as printed clay coated paper, one or more additional film layers, including an exterior film layer, a kraft paper layer, and a variety of other layers of material. Various other layers known to those of skill in the art of construction of multi-layered bags may be implemented to make a bag as disclosed herein.

Where the multi-layer construction includes an inner plastic film layer and a middle paper layer, those layers may be adhered together via a hot melt adhesive. Where the multi-layer construction includes an outer plastic film layer and a middle paper layer, those layers may also be adhered together via a hot melt adhesive. Where the SOS bag is multi-layered, the layers may themselves be adhered together in a variety of manners, including a flood coat of hot melt adhesive between the layers.

In an embodiment, a film layer may be adhered to any adjacent layer via laminating the film to said layer. For example, an inner plastic film layer may be laminated to a middle clay coated paper layer, and an outer film layer may be laminated to said middle clay coated paper layer.

The tube may, in an embodiment, be a single layer of plastic material, or alternatively a web of multi-layered plastic may be laminated together to form an effectively single ply such that the individual layers are not distinguishable or separately manipulable. This is distinct from the, for example, multi-layered construction that includes an inner plastic film layer, a middle kraft paper layer, and an outer printed clay coated paper layer, where each of those layers is still recognizable and distinct, and might be at least partially independently manipulated via bag manufacturing machinery.

In an embodiment of an effectively single ply plastic laminate, an inner layer of woven oriented polypropylene may be laminated to an outer layer of reverse printed oriented polypropylene to make an effectively single layer web of material. Reverse-printed is understood to mean a substantially transparent or translucent plastic film that has been printed with backwards text and/or imagery that is visible through the plastic film such that the text and/or imagery is legible, i.e. not backwards, when viewed from the side of the film opposite from where it has been printed. Alternatively, an inner non-woven plastic film layer and an outer reverse printed plastic layer may be laminated together to form an effectively single layer web of material. Additionally, a single ply of plastic film may be used to make a bag as disclosed herein. Where heat seals are used, as opposed to seals effected via glue or hot melt adhesive, a plastic-to-plastic bond may be used, where one plastic film or layer would be bonded to an adjacent plastic film or layer.

These non-limiting examples and others are fully embraced by the scope of this disclosure as the construction material into which a bag of the disclosure is made by the methods disclosed herein.

The gusseted tube of indefinite length into which a bag of the disclosure may be made can be created in a variety of ways. In an embodiment, a substantially continuous sheet of material having a consistent width and an indefinite length may be fed along a machine and by its length and manipulated and folded onto itself across its width to create an overlap of material. At the overlap, the material may be sealed to itself to create a tube of material. This folding may include folding to create gussets that run the length of the material to create the gusseted tube, where the folding of the gussets may happen before, after, or in substantial synchronization with the sealing of the material.

Where the sheet of material is fed along a machine, the material may be fed, for example, from a spool of material, or from an apparatus that creates plastic sheeting from raw plastic materials such as pellets. Or, in another embodiment, the material may be fed from a series of spools and laminated together to turn a multi-layer construction into an effectively single layer construction.

FIG. 3 shows an example of a method of creating a gusseted tube 200. Specifically, FIG. 3 shows a portion of material that has been folded to create gussets 202 as well as a heat sealing apparatus 300 operating on a machine where the tube is moving in a first direction 302 relative to the stationary heat sealing apparatus. In this embodiment, the seal is being created by selective application of hot air via a nozzle 304 onto an inner edge 204 of the material as the tube 200 moves in the first direction 302. As the tube continues along the machine in the first direction, the now at least slightly molten plastic material that comprises the inner edge 204 of the material is pressed against a corresponding outer edge of material 206 to provide compression and thereby adhere the two edges together and create an overlap 208, which may be referred to as a side seam. The pressing may be effected by, for example, a roller 306 in close proximity to a hot air nozzle. The tube may be manipulated in this method via various subsequent rollers 308 known in the art of bag manufacturing. In this way, the tube 200 may be completed, and the side seam 208 runs the length of the tube and is substantially parallel to the folds that define the front and back panels and the gussets. It should be noted that the selective hot air is applied in this embodiment to the inner edge of the overlapping material and not to the outer edge of material being overlapped, as the outer edge in this example is adjacent to the flat folded gussets. If the hot air was to be applied to the outer edge, being adjacent to the flat folded gussets, then, depending on various factors including the construction of the material and the geometry of the gussets relative to the side seam, the manufacturer runs the risk of undesirably heat sealing the gussets, resulting in a non-functional gusset and bag.

In an alternative embodiment, the material may be cut into planar segments of material of substantially equal lengths and then folded and sealed along an overlap to create side seams as individual tube portions, as opposed to being sealed along an overlap in a sheet of indefinite length which is then separated into individual tube segments.

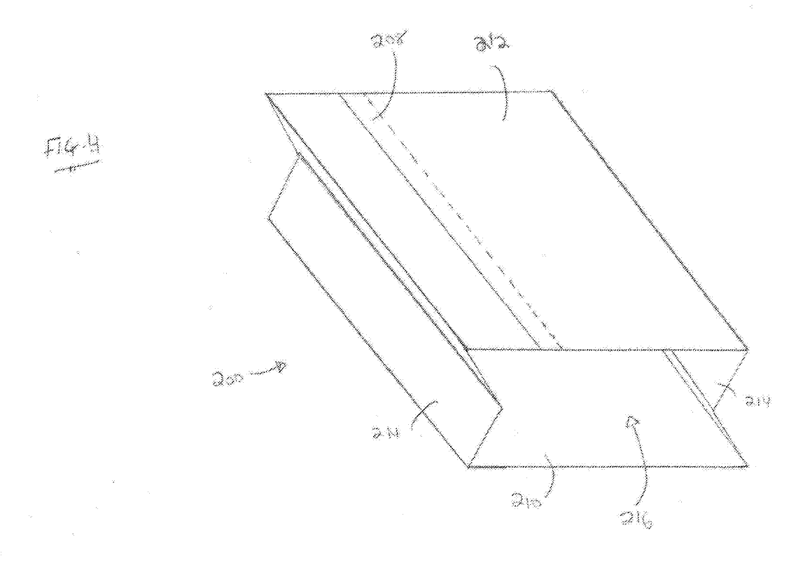

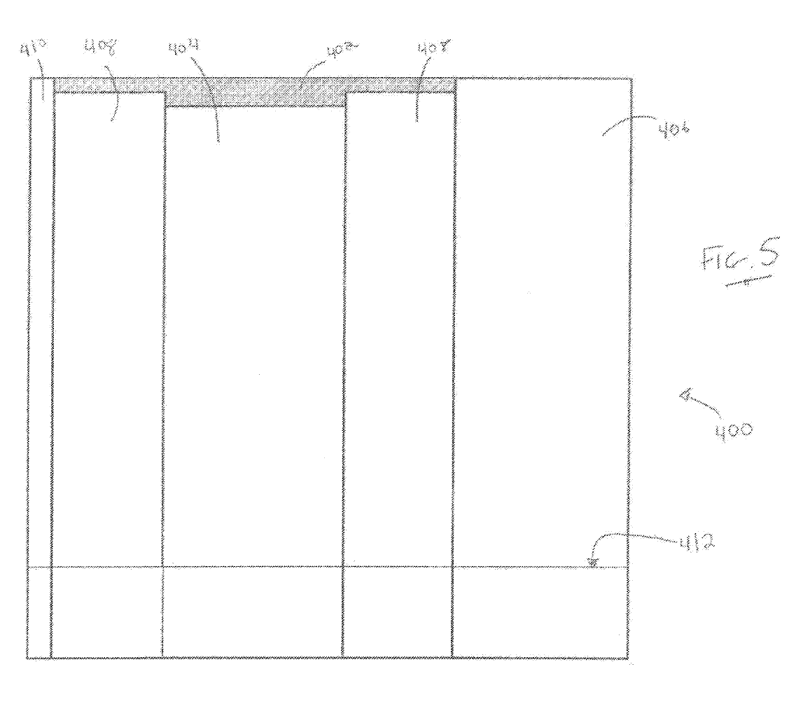

FIG. 4 shows an embodiment of a gusseted tube 200 of indefinite length that may be used to create a bag of the disclosure, this figure including detail of an embodiment of a side seam 208, including a side seam created via the aforementioned selectively applied hot air sealing method.

Although hot air sealing has been described, other sealing mechanisms may be used at various points of the manufacture of the bag of the disclosure. For example, ultrasonic sealing, also known as ultrasonic welding, is a method of applying high-frequency ultrasonic acoustic vibrations to a substrate to create a solid-state weld between two surfaces. This can be done selectively via an ultrasonic horn in combination with an anvil and wheel as the substrate moves in a lateral direction past the ultrasonic welding station. In another embodiment, a conventional heat bar may be used in some instances. A heat bar may be a heated element, often in the shape of a linear mass, such as a bar, to apply heat directly to a surface, thereby causing a brief molten state to a plastic material. In either instance, pressure in the form of, for example, a rolling mechanism could be used to press two surfaces together when one or more has received a sealing application to provide a snug seal between the surfaces. In another embodiment, a hot melt adhesive may be used to seal two surfaces, where a hot melt is an adhesive applied between surfaces that may then be pressed together. These and other mechanisms known in the art for sealing two surfaces of material are embraced by this disclosure.

Bags of the disclosure are manufactured in part via a new bottom closure process that will be described hereinafter. However, the top of the bag may vary based upon the desires of the bag customer. The bag customer may be a dog food manufacturer, for example, who might want the top of the bag in one type of configuration or another. A flush cut bag is understood to mean a bag where the upper edges of the bag are substantially flush. In a flush cut bag, where the SOS bag is open and resting with the bottom of the bag on a horizontal surface, the upper edges of the bag generally define a horizontal plane parallel to the bottom of the bag. A step cut bag, by comparison, includes a first panel of a first height, gussets of a second height slightly shorter than the first panel height, and a second panel of a third height, slightly shorter than the gusset height. A Z cut bag, includes a first panel of a first height and a second panel of a second height, where the transition between the two panels along the gussets is a single diagonal cut that, when the tube and gussets are folded flat, resembles a Z or backwards Z, depending on which gusset is being viewed. Flush cut, step cut, and Z cut are all known terms to those of ordinary skill in the art with respect to gusseted bags. These and other tops, including those suitable for accepting various closure and reclosure apparatuses, are all embraced by this disclosure.

The gusseted tube of FIG. 4 includes a front panel 210 and a back panel 212, joined by two gussets 214, the tube having an interior cavity 216. Although in this figure a front and back have been assigned such that the seam is on the back panel, this disclosure is not intended to be so limiting.

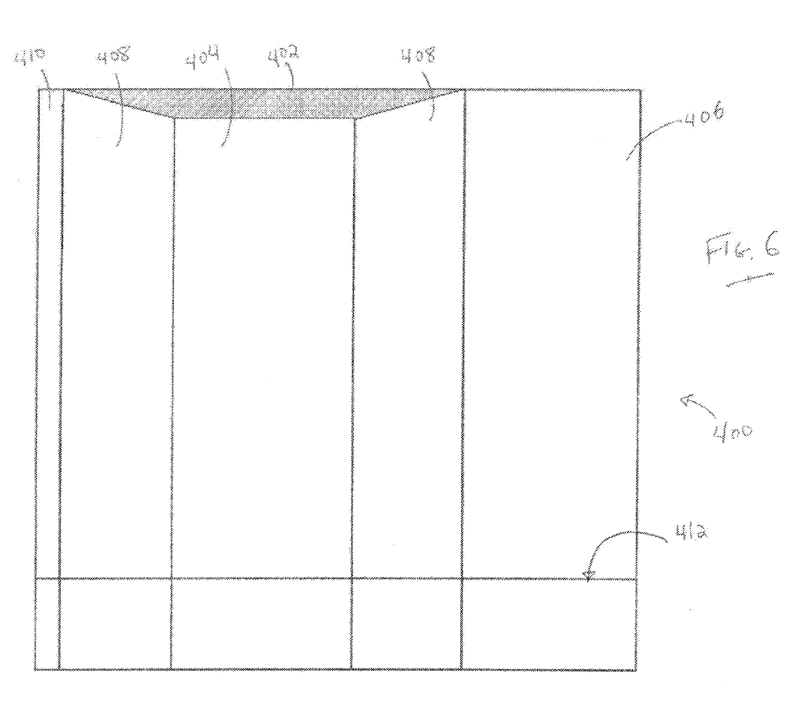

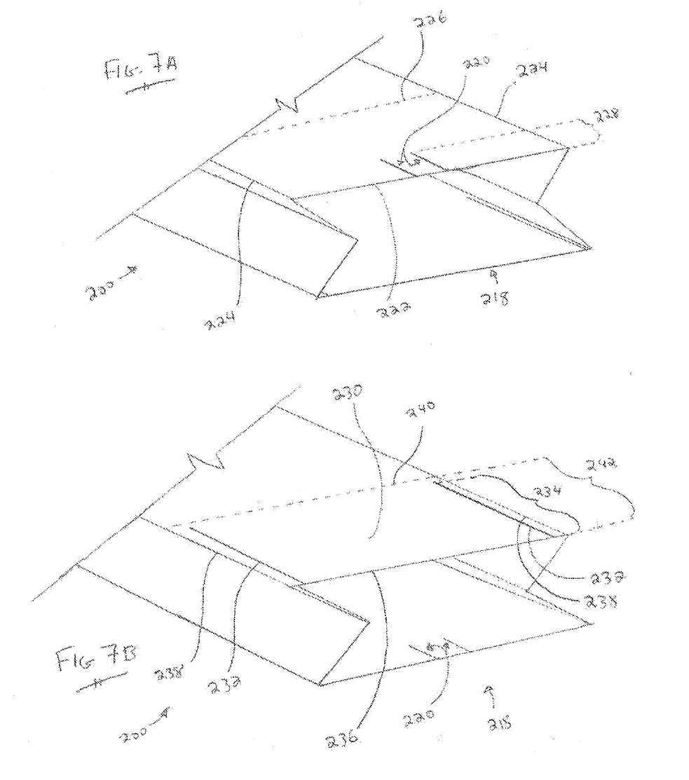

FIG. 5 shows a step cut die cut pattern suitable for use in manufacturing a bag of the disclosure, and FIG. 6 shows a Z cut pattern suitable for use in manufacturing a bag of the disclosure. Where die cutting of the top of the bag is desirable, in an embodiment the die cutting of the material occurs before the folding and sealing of the material into the gusseted tube of indefinite length. In this way, where a step cut or Z cut is to be on the final product bags, the gusseted tube of indefinite length will include a series of equally spaced apart die cuts corresponding to the unfolded die cut patterns of FIGS. 5 and 6. Alternatively, the die cutting of the tops of the bags may occur after each gusseted tube is cut into individual segments. In another embodiment, the die cutting may occur before the creation of the gusseted tube, at intermittent distances on a continuous length of material. In yet another embodiment, the die cutting may occur before the creation of a gusseted tube on individual panels of material that may then be formed into gusseted tubes.

It should be understood that die cutting of the patterns seen in FIGS. 5 and 6 is not intended to be limited strictly to literally die cutting of the material. Indeed, all cutting or other mechanisms for separation of the grayed areas shown in FIGS. 5 and 6, and cutting to produce other tops of bags, are embraced by this disclosure. Further, the dimensions and ratios seen in FIGS. 5 and 6 are not meant to be so limiting, as these figures are embodiments intended to show various configurations of the top of the bag. A bag of the disclosure may have any suitable width, length, height, etc. and still be embraced by the claims.

Specifically, in FIGS. 5 and 6, an area of material 400 into which a bag of the disclosure will be formed may receive one or more cuts to create a section of material to be removed 404 to generate the specific respective cut of the top of the eventual SOS bag. These figures additionally show fold lines that will eventually define the future front panel 404, the future back panel 406, and future gussets 408 of the bag. A region of future overlapping section 410 is also present, as seen in FIG. 3, which will include a portion of overlapping that results in the side seam that will define the gusseted tube of the disclosure. A future bottom fold line 412 that defines portions of the material that will eventually make the bottom of the bag runs the width of the area of material 400 is also shown in FIGS. 5 and 6.

Gusseted tubes as described herein include a bottom end that undergoes manipulations and sealings to create the bag of the disclosure, where the top end of the tube is the location that the cut pattern of FIG. 5 or 6, when applicable, would reside. The bags may be cut into segments of gusseted tubes which will then be manipulated and sealed to create the SOS bag of the disclosure. Where a flush cut is desired, cutting of the tube of indefinite length into individual segments will create the flush top of the bag.

An exemplary method of manufacturing a bag of the disclosure will now be described. In a preliminary step, a section of gusseted material as previously described herein is provided.

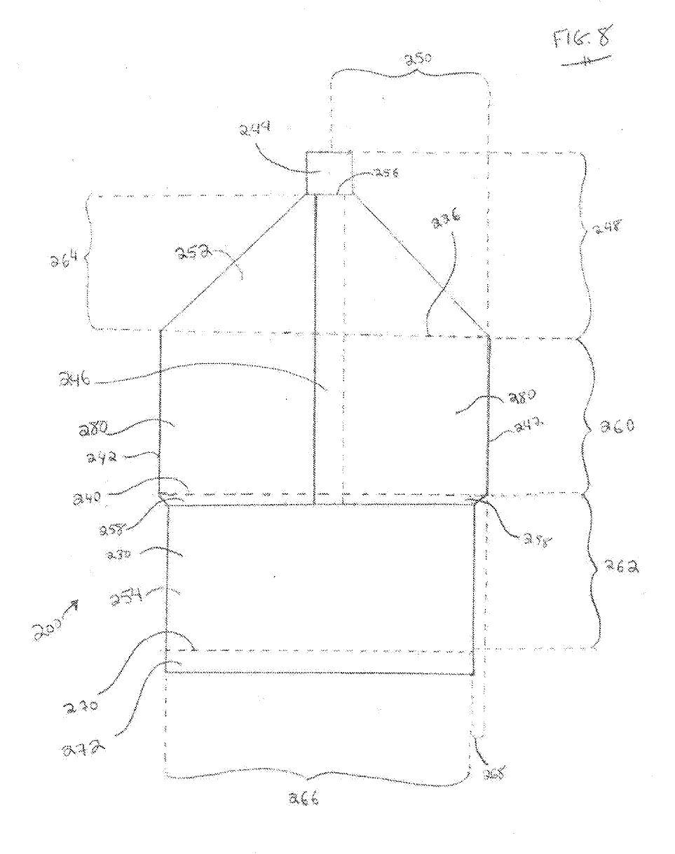

Turning further to the figures, FIGS. 7A and 7B show an exemplary cut pattern for the bottom of the segment of gusseted tube 200. In a first step, the bottom 218 of the gusseted tube may be die cut according to the pattern seen in FIGS. 7A and 7B, where FIG. 7A shows a view of the front of the gusseted tube and FIG. 7B shows a view of the rear of the gusseted tube.

FIG. 7A, more specifically, shows the outer surface of the bottom of the panel of the gusseted tube that will become the front panel of the bag of the disclosure. In this embodiment, two parallel front flap cuts 220 of equal length 228 are made on the bottom edge 222 of the panel, equidistant from the outer edges 224 of the front panel, near the center of the width of the panel. FIG. 7A also shows, by way of hashed lines, a front flap fold line 226. This front flap fold line 226 will be the fold about which a front flap is folded inwardly towards the center of the bottom of the gusseted tube as a part of the creation of the bottom of the bag in future steps.

FIG. 7B is a view of the gusseted tube 220 of FIG. 7A, but showing the outer surface of the bottom of the panel of the tube that will become the rear panel of the bag of the disclosure. In this embodiment, two parallel rear flap cuts 232 of equal length 234 are made on the bottom edge of the panel 236 near the outer edges 238 of the bottom of the panel, equidistant from the outer edges of the back panel. FIG. 7B also shows, by way of hashed lines, a rear flap fold line 240. This rear flap fold line will be the fold about which the rear flap is folded inwardly toward the center of the bag, after the front flap has been folded inwardly, to complete the bottom of the bag. These rear flap cuts 232 run from the bottom edge 236 of the tube towards, but do not meet, in this embodiment, the rear flap fold line 240. Thus the distance 242 of the rear flap fold line 240 from the bottom edge of the panel 236 is slightly greater than the length 234 of the rear flap cuts 232. The rear flap cuts seen in FIG. 7B, create the structure of the flat bottom display 230 and, together with the rear flap fold line and the bottom edge of the rear panel of the tube, define the outer edges of the flat bottom display 230. The rear flap fold line 240 may be the same distance from the bottom edge 236 of the rear panel as the front flap fold line 226 is from the bottom edge 222 of the front panel.

It should be noted that where the terms “front” and “rear” are used herein, these need not necessarily be the literal front or back of the bag. These terms are merely being used herein to aid in describing the various steps of making the bag of the disclosure.

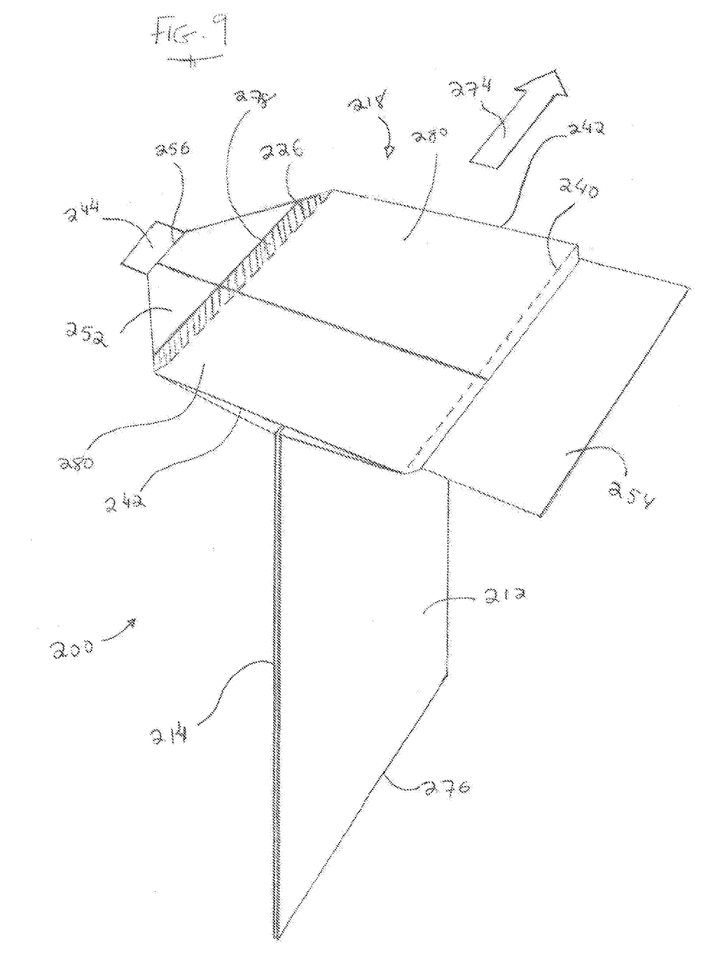

FIG. 8 shows the gusseted tube 200 of FIGS. 7A and 7B, including details of a second step in the manufacturing process, as viewed from the bottom of the tube, this step including the inward folding of the gussets 214 along gusset bottom fold lines 242 to create inwardly folded gussets 280 on the bottom of the tube. This second step where the gussets are inwardly folded towards each other into the interior of the tube leaves two portions of the bottom of the tube unfolded. The two parallel front flap cuts of equal length on the bottom edge of the panel define a front flap trim region 244 that remains unfolded in this step, and the two parallel rear flap cuts of equal length near the outer edges of the bottom of the panel define the flat bottom display 230 that also remains unfolded in this step. The gusset bottom fold lines are the same distance from the bottom edge of the gussets as the panel fold lines are from the bottoms of their respective panels.

As can be seen in FIG. 8, the bottom edges of the inwardly folded gussets at least partially overlap to create a gusset overlap region 246. This gusset overlap region, the benefits of which will be explained hereinafter, is achieved as a result of the front flap fold line 226, designated by hashed lines in FIG. 8, being located at a distance 248 from the bottom edge of the gusseted tube that is slightly greater than half the distance 250 across the front panel of the gusseted tube.

The two parallel front flap cuts of equal length on the bottom edge of the panel enable the inward folding of the gussets to create the gusset overlap region 246. Without the front flap cuts, the overlap region would, at its tip, create a challenge in folding of the material or perhaps a difficult physical configuration to overcome. These cuts allow the easy inward folding by eliminating any gusset overlap at the edge of the flap, were the front flat trim region 244 resides.

As a result of the gusset folding as seen in FIG. 8, a front flap 252 and a rear flap 254 are defined. Thus, the front flap 252 is the portion of the folded gussets and front panel beyond the front flap fold line 226 away from the interior of the bag. The rear flap 254 is the flat bottom display 230 and two small regions of folded rear panel 258 of the gusseted tube beyond the rear flap fold line 240, designated by hashed lines in FIG. 8, away from the interior of the bag. The gussets are inwardly folded in FIG. 8 along gusset bottom fold lines 242. The two flap fold lines 240, 226 and the two gusset bottom fold lines 242 together define the circumference and shape of the rectangular bottom of the SOS bag of the disclosure. Additional measurements show in FIG. 8 will be discussed hereinafter.

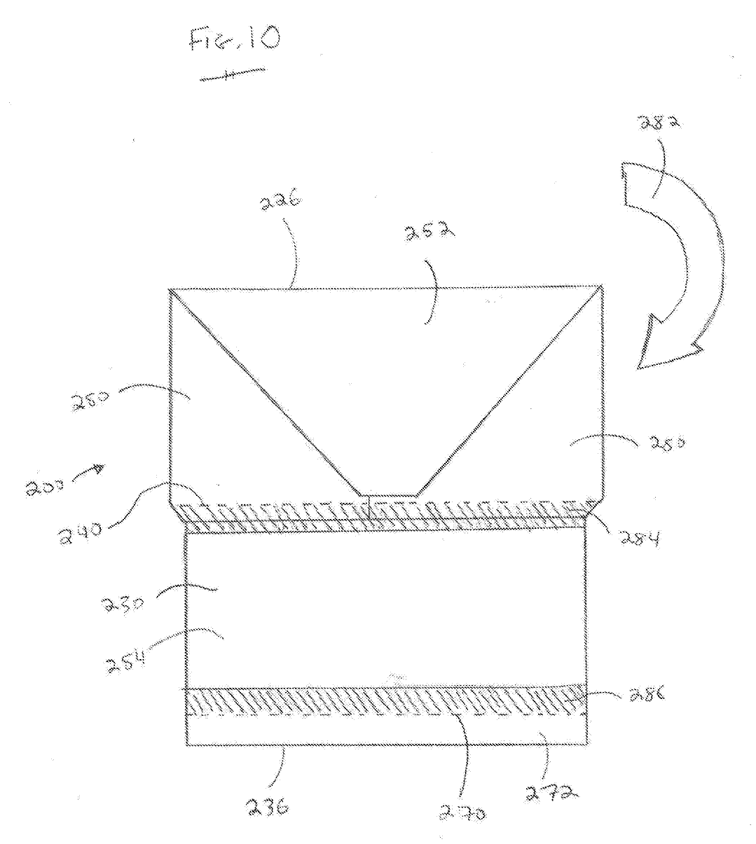

After the folding step of FIG. 8, a third step is seen in FIG. 9, where the gusseted tube 200 is presented to a sealing apparatus in a T shape in a sealing direction 274. In this way, in an embodiment, the bottom 218 of the SOS bag, the front flap 252, and the rear flap 254, are substantially parallel and horizontal and represent the top of a capital T, while the remainder of the folded gusseted tube that represents a large portion of the body of the bag of the disclosure makes up the vertical portion of the T, where the tube is inverted with the bottom up and the top edge of the bag 276 aimed downwardly. In an embodiment, the steps of the manufacturing process, including the formation of the gusseted tube, take place in a first direction, where the tube moves down a manufacturing line bottom first, where the bottom is the bottom of the eventual SOS bag. At some point, including in an embodiment after the folding as seen in FIG. 8, the gusseted tube is manipulated by machinery into the T shape and rotated ninety degrees. In this way, the gusseted tube is now approaching the sealing apparatus gusset-first in a sealing direction 274, as indicated in FIG. 9.

FIG. 9 shows the configuration and presentation of the gusseted tube of FIG. 8 in a T shape to a sealing apparatus, including details of a first sealing region 278, designated by a hash-lined area. In a fourth step of an embodiment of the bag manufacturing process, the front flap trim region is at least partially removed from the tube, via cutting along the front flap trim line 256, for example, giving the front flap a substantially isosceles trapezoid shape. In cutting off the front flap trim region 244, as seen in FIG. 8, the length 264 of the front flap 252 is made at least slightly shorter than the length 260 of the bag, which is the length between the front flap fold line 226 and the rear flap fold line 240. In this way, when the front flap 252 is folded inwardly and sealed into the bottom of the SOS bag, the front flap trim region 244 is removed and the length 264 of the front flap has been shortened to accommodate the length 260 of the bottom of the bag.

In an alternate embodiment of the fourth step, the front flap trim region 244 may be folded about the front flap trim line 256 onto the gusset overlap region 246 to create a front flap 252 that is at least slightly shorter than the length 260 of the bag. In this way, the fourth step of this embodiment of the disclosed method may be to bring the front flap down to a length 264 that is at least partially shorter than the length of the gussets and thus the length of the bag, so as to enable a folding of the flap in a manner similar to that when the front flap trim region is removed.

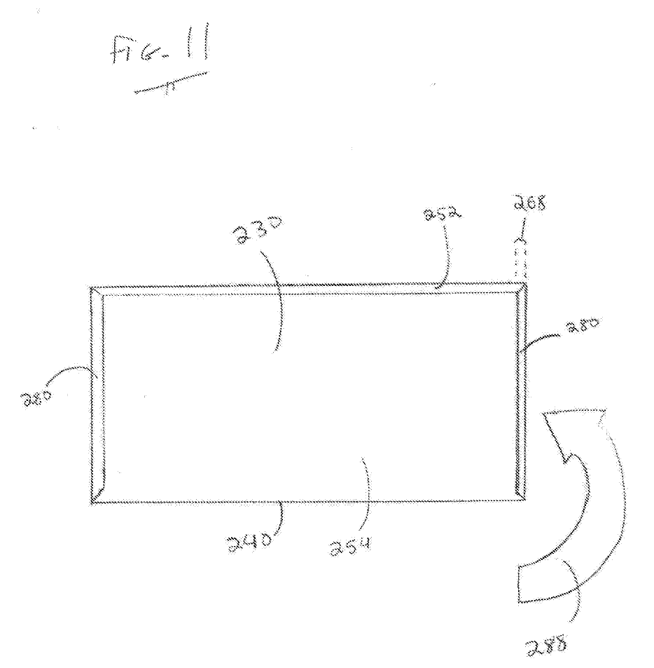

FIG. 9 additionally shows a first heat seal region 278 of the bottom 218 of SOS bag, the first heat seal region 278 being on the front flap 252, parallel to and in proximity to the front flap fold line 226. The first heat seal region may optionally abut the front flap fold line. In a fifth step, a heat seal may be applied to the first heat seal region 278 via the previously-described hot air mechanism, for example, where the bag, in a T shape, is being moved gusset-first in the sealing direction 274, down a machine line and a stationary hot air nozzle applies selective hot air to a portion of the front flap 252 in the first heat seal region 278 in conjunction with a folding of the front flap 252 about the front flap fold line 226, and a roller or other compression mechanism applies pressure to the outside of the folded front flap to adhere the now at least partially molten plastic of the front flap to the inwardly folded gussets 280 to complete a front flap seal. In an alternate embodiment, the first heat seal region may run along the front flap fold line, effectively applying heat to both the front flap and the inwardly folded gussets to effect the seal. In another embodiment, the heat seal may only be applied to the inwardly folded gussets onto which the front flap is folded. The results of this fifth step is the configuration of the gusseted tube seen in FIG. 10.

FIG. 9 and the first heat seal region 278 demonstrate the importance of the previously-discussed gusset overlap region 246. This gusset overlap region is unique in the art with respect to plastic bag constructions and at least partially enables the SOS bag of the disclosure to be made by the method disclosed herein. If the gusset overlap region was not present in the bags of the disclosure, the heat seal method disclosed herein would not result in a functional bag. As detailed in an embodiment herein, the heat seal is applied across the width of the front flap, which is then folded along the front flap fold line. In this way, the gusset overlap region folds over onto itself and is sealed to itself. If, instead, there was no gusset overlap region such that the two bottom edges of the gussets remained some distance apart when inwardly folded to create a gap therebetween, then a heat seal applied across the width of the front flap would be applied within that gap to the interior of the gusseted tube material. Then, when the front flap is folded inwardly, the portion of the material on the front flap in that gap that has received a hot air heating, for example, would fold onto and seal against a portion of the interior of the bag. The result of such a heat seal is a non-functional bag that does not have a proper SOS opening. That failure is overcome by virtue of having a gusset overlap region where the heat seal may be applied so that the front flap may fold inwardly without sealing itself to the interior of a panel of the bag.

FIG. 10 shows the gusseted tube 200 of FIG. 9, still in a T shape at a sealing apparatus, when viewed from the end of the tube that will become the bottom of the bag, the front flap 252 having been folded and sealed as previously discussed about the front flap fold line in a front flap folding direction 282. FIG. 10 further shows a second heat seal region 284 and a third heat seal region 286, each heat seal region designated by hash-lined areas in FIG. 10, as well as the rear flap fold line 240 and a rear flap trim line 270. In a sixth step, the rear flap is trimmed along the rear flap trim line 270 to remove a rear flap trim region 272, which is the region of the rear flap 254 beyond the edge of the rear flap trim line and out to the bottom edge 236 of the rear flap. Similar to the management of the front flap trim region 244, the purpose of this sixth step is to bring the rear flap into a length 262 that aligns with the length 260 of the bottom of the bag, as seen in FIG. 8. The rear flap trim line 270 is parallel to the rear flap fold line 240 and runs the entire width 266 of the display area 230 of the rear flap 254, such that cutting along this line will trim off the rear flap trim region 272. Referring again to FIG. 8, the distance 262 of the rear flap cut line to the rear flap fold line is up to just below the distance between the rear flap fold line and the front flap fold line 260, which is the length of the final assembled bottom of the bag. In this embodiment the bottom edges of the trimmed rear flap may come close to but not quite meet the front flap fold line.

The second heat seal region 284 is a region of heat sealing parallel to and in the general vicinity of the rear flap fold line 240, and may be analogous to the first seal. This second heat seal region, as seen in FIG. 10, may be on the rear flap 254 near the rear flap fold line 240. In an alternate embodiment, the second heat seal may run along the rear flap fold line, effectively applying heat to both the rear flap and the inwardly folded gussets to effect the seal. In another embodiment, the heat seal may only be applied to the inwardly folded gussets onto which the rear flap is folded.

The third heat seal region 286 is, in an embodiment, the final region of heat sealing and is on the rear flap 254 parallel to and in the general vicinity of the rear flap trim line 270, running the length of the bottom edge 236 of the rear flap.

In a seventh step, a second heat seal is applied in the second heat seal region 284 via the previously-described hot air mechanism, for example, where the bag is being moved gusset-first in the sealing direction 274, down a machine line and a stationary hot air nozzle applies selective hot air to the second heat seal region 284 in conjunction with a folding of the rear flap 254 about the rear flap fold line 240 onto the inwardly, folded gussets 280, the gusset overlap region 246, and the previously-folded front flap 252, and a roller or other compression mechanism applies pressure to the outside of the folded rear flap to adhere the now at least partially molten plastic of the rear flap to the inwardly folded gussets and front flap.

In an eighth step, a third heat seal is applied in the third heat seal region 286 via the previously-described hot air mechanism, for example, where the bag is being moved gusset-first in the second direction 274, down a machine line and a stationary hot air nozzle applies selective hot air to the third heat seal region 286. Here, the rear flap 254 has previously been partially folded onto the inwardly folded gussets 280 and front flap 252 in the seventh step, and a roller or other compression mechanism applies pressure to the rear flap near the rear flap trim line 270 to adhere the now at least partially molten plastic of the rear flap to the inwardly folded gussets and front flap, thereby completing the construction of a bag of the disclosure.

Preferably the side seam of the gusseted tube is on the front panel and thus the front flap. This permits a clean, uninterrupted surface for display on the bottom of the bag, whereas a rear flap with a side seam running down it could create issues with printing and appearance.

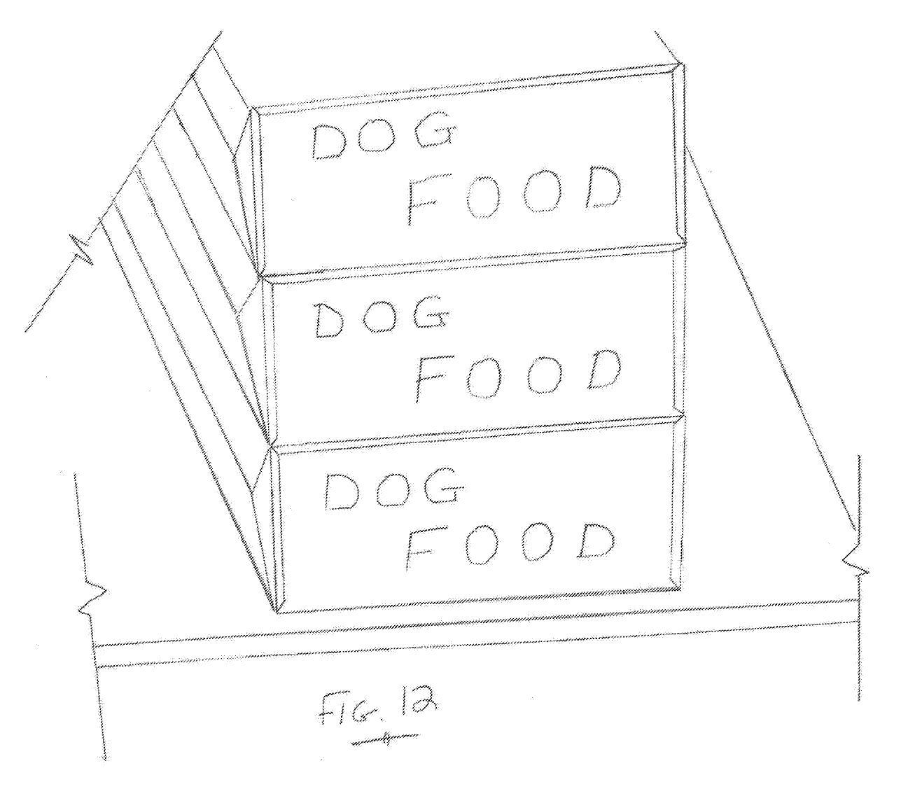

The completed gusseted bag of the disclosure, as seen now from the bottom in FIG. 11, having undergone the previous steps, including the folding of the rear flap 254 about the rear flap fold line 240 in a rear flap folding direction 288, may now continue past the heat sealing mechanism to be prepared for shipment to a consumer, for example. Bags of the disclosure may be filled and stacked on shelving with the bottom flap outwardly visible towards consumers, an embodiment of which can be seen in FIG. 12.

In an optional step, before the front flap is folded over onto the overlapped gussets and sealed thereto, the gusset overlap region may itself be heat sealed, for example by applying hot air to the overlapping bottom gusset via a hot air nozzle and compressing it to the overlapped bottom gusset via one or more rollers. In this way, in conjunction with the other seals applied in subsequent steps, the bottom of the bag may be substantially sealed for applications where a liftable material, such as flour, could be introduced into the bag and not escape around the overlapped gussets and out the sides of the bottom of the bag.

An SOS bag of the disclosure manufactured via the foregoing method will now resemble the prior art SOS bag of FIGS. 1 and 2, with the distinction that the bottom of the bag of the disclosure includes a unique construction manufactured via a unique method.

In an embodiment of a heat sealing mechanism of the disclosure, each heat sealing mechanism includes a nozzle for selectively applying hot air to a portion of the material and a subsequent roller to apply pressure to push two portions of material together to create the heat seal. In this mechanism, there is a direction which the material travels, while the heat sealing mechanism remains stationary, for example as one of a plurality of stations on a manufacturing line.

Where hot air heat sealing is used, the heat applied to the substrate will vary based on several factors, including the speed of manufacture in bags per minute and the material being heat sealed. The pressure required to effectuate the heat seal by pressing the at least partially molten material onto another substrate will also be determined by the speed of manufacture of the bags, the material being sealed, and the temperature of the hot air. The specific settings for the heat, speed, pressure, etc. may be calibrated on an individual basis on each machine and will vary from one machine to another, and from one process to another. Generally, though, hot air heat sealing stations may operate at a temperature range of 100 to 1,500 degrees Fahrenheit, although to make bags relatively quickly a higher range of 500 to 1,500 degrees may be preferred. Specific tolerances will vary by machine and substrate, but can typically fluctuate 25 degrees above or below the ideal conditions for bag manufacture and still make a quality product, based on a desired bag manufacturing speed. Many modern machines can manufacture bags at a rate of 60 to 80 large bags, such as those capable of holding bulky dog food, per minute, with higher end machines producing up to 100 per minute. As the speeds increase, so will the heat of the hot air and the corresponding pressure of the rollers. With bags moving faster down an assembly line, the hot air must be increased to compensate for the reduced time of exposure of the substrate to the hot air. The same may be said for any compression rollers, which might need additional pressure as bags move faster past the hot air sealing station.

Similarly, where ultrasonic welding takes place as a part of the manufacturing process, the desired speed of manufacturing of the bags will govern the vibration frequency and pressure between the horn and anvil for each bag. Where an ultrasonic station must operate more quickly, the vibration frequency and pressure may be increased. Additionally, where the substrate demands, the specific settings of the ultrasonic welding station or stations.

It will be appreciated by those of skill in the art that the various steps disclosed herein may be conducted by machinery in one or more manufacturing machines, and those machines may include a variety of tracks, wheels, rollers, and other known bag manufacturing machine components, including mechanisms to transfer the bag along the machine from beginning to end and between individual stations, such as sealing stations. Indeed, one could manufacture a bag of the disclosure at least partially by hand, escorting the gusseted tube from one station to another, such as individual sealing machines, or by making the bag of the disclosure on one or more manufacturing machines. All possible configurations of bag manufacturing machines that could be conceived by one of skill in the art that assemble a bag of the disclosure or practice the method of this disclosure are thus embraced by this disclosure, and this disclosure should not be limited to a single manufacturing machine with only the stations described herein.

The embodiment showing the location of the rear flap cuts as near, but not at, the outer edges of the back panel, is in part due to the nature of the material from which the gusseted tube may be constructed. Plastic film, by its nature, has memory as a property. By memory, it is understood that plastic film wants to return to its original planar structure and doesn't provide the crisp, clean ninety degree folds that a paper material, for example, might provide. So where the gusseted bag is constructed of a substantially plastic material, such as for example an effectively single ply constructed by laminating an inner woven oriented polypropylene layer with a reverse printed oriented polypropylene film layer, long folds of this material will not have totally crisp ninety degree folds that retain their shape at the same level as a paper bag, such as the brown paper lunch sack discussed earlier herein. Because plastic has memory, the various folds of the gusseted tube and additionally the finished product gusseted SOS bag of the disclosure will not be sharp bends, but rather very subtle curves at the folds. Even after folding along a crease, the plastic material will try, even if only slightly so, to curve back into a plane. When folding the flat bottom display about the rear flap fold line and sealing it to complete the bottom of the bag, having the outer edges of the bottom display flush with outer edges of the bottom of the bag might not result in as effective of a seal because of the memory of the plastic at those bends of the gussets into the bottom of the bag. The die cut outer edges of the flat bottom display in that instance might not adhere to the rest of the bottom of the bag while the folded plastic is attempting to return to a planar shape. Instead, by having the rear flap cuts near, but not at, the outer edges of the back panel of the tube, the outer edges of the bottom display may be tightly sealed against the bottom of the bag, resulting in a more complete seal. Ideally, in order to achieve the largest display area possible, one would like to have the rear flap cuts align with the folds that separates the bottoms of the gussets from the back panel, but plastic memory prevents this level of efficiency.

Thus a method of manufacturing a new flat bottom SOS bag has been disclosed, including the preliminary step of providing a gusseted tube of indefinite length. In a first step, the bottom of the gusseted tube may be cut on the bottom of the front and back panels to provide two parallel front flap cuts of equal length, near the center of the width of the panel, and two parallel rear flap cuts of equal length near the outer edges of the panel. In a second step, the gussets are inwardly folded towards each other into the interior of the tube to at least partially overlap. In a third step, the gusseted tube is presented to a sealing apparatus in a T shape in a sealing direction, the tube having a front flap and a rear flap. In a fourth step, a portion of front flap maybe cut off or folded. In a fifth step, a heat seal may be applied to a first heat seal region on the front flap in conjunction with an inward folding of the front flap. In a sixth step, a portion of the rear flap may be cut off or folded. In a seventh step, a second heat seal may be applied to a second heat seal region on the rear flap in conjunction with an at least partial inward folding of the rear flap. In an eighth step, a third heat seal may be applied to a third heat seal region on the rear flap in conjunction with the completed inward folding of the rear flap.

Additionally, a new SOS bag is disclosed. Bags of the disclosure may include a gusseted bag having a front and back panel joined by gussets, where the bottom of the SOS bag includes a pair of inwardly folded gussets, and inwardly folded front and back flaps to create a folded bottom. The bags disclosed herein may have a substantially rectangular flat bottom rear flap heat sealed to the inwardly folded front flap and inwardly folded gussets at the bottom of the bag. The gussets may overlap beneath the front flap and rear flap. The front flap and/or rear flap may be trimmed and/or cut to bring them into a length less than that of the gussets. A bag may include a plurality of heat seals about the bottom of the bag closure, including a series of substantially parallel hot air seals between the front flap and the inwardly folded gussets, and/or the rear flap and the inwardly folded front flap and/or gussets.

Bags of the disclosure provide several advantages over conventional bags of the prior art. For example, in the packaging of pet food, bags of the disclosure have various specific benefits. Pet food, including dry dog food, can be a greasy and heavy product. In the past, the packaging industry had embraced the use of paper-based or paper composite bags for dog food. However, at as the size of the bag, and thus the weight and volume of the dog food contained therein, increased, consumers and retailers were met with more frequent failures of the bag integrity, resulting in loss of product, mess in the retail environment, and negative consumer experiences.

As the industry shifted away from paper-based bag construction, woven oriented polypropylene became more favored, due to its substantially improved strength, particularly its resistance to puncture. Dog food became increasingly stored in bags constructed of a ply of woven oriented polypropylene (OPP) laminated with a layer of reverse printed plastic film, with the woven OPP on the inside of the bag against the food. These bags, by virtue of the construction material, in some instances provided less flexibility and less opportunity for attractive printing. Many of these large woven OPP were rolled and heat sealed on the bottom, which did not provide an attractive or particularly useful area for the dog food company to print. Large, heavy bags of pet food (or other goods) tend to lay on their sides in a retail environment, giving increased value to the bottom of the bags for printing.

Bags of the present disclosure, however, attempt to overcome the failures of the art. Bags disclosed herein allow the printing of logos and other information to attract consumers on the bottom of the bag in a clean, consistent manner on a substantially congruent surface. Bags can be stored laying down with the bottom-out and facing consumers, allowing for more product to be stored on shelves. Additionally, the rectangular bottoms of the bags, paired with the gusseted shape of a traditional SOS bag body, will allow tighter stacking of bags of product, both on top of each other and in adjacent columns of product. These and other advantages associated with the bags of the present disclosure will be apparent to those of ordinary skill in the art.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention as well as all equivalents thereof.

We claim:

1. A gusseted bag comprising a front panel and rear panel joined by a pair gussets, the front panel, rear panel, and gussets each having respective bottom edges,
wherein the gussets are inwardly folded along gusset bottom fold lines to at least partially overlap and create a gusset overlap region,
the bag further comprising a front flap and a rear flap, wherein the front flap is a portion of the folded gussets and the front panel beyond a front flap fold line, and wherein the rear flap is a portion of the gussets and the rear panel beyond a rear flap fold line,
the rear flap comprising two rear flap cuts on the bottom edge of the rear panel, where the rear flap cuts run from the bottom edge of the rear panel towards the rear flap fold line, wherein the distance between the bottom edge of the rear panel and the rear flap fold line is greater than the length of the rear flap cuts,
wherein the front flap is folded about the front flap fold line onto the inwardly folded gussets, and wherein the rear flap is folded about the rear flap fold line onto the inwardly folded gussets and rear flap,
the bag further comprising a rectangular bottom comprising the front flap, the rear flap, and the inwardly folded gussets.

2. The gusseted bag of claim 1, wherein the front flap is sealed to the inwardly folded gussets at a first seal region, the first seal region being on the front flap parallel to and in proximity to the front flap fold line,
and wherein the rear flap is sealed to the inwardly folded gussets and front flap at a second seal region and a third seal region, the second seal region being on the rear flap parallel to and in proximity to the rear flap fold line, and the third seal region running the length of the bottom edge of the rear panel.

3. The gusseted bag of claim 2 wherein the front flap is sealed to the inwardly folded gussets at a first seal region via selective hot air sealing, and wherein the rear flap is sealed to the inwardly folded gussets and front flap at a second seal region and a third seal region via selective hot air sealing.

4. The gusseted bag of claim 1 wherein the rear flap cuts are parallel and of equal length, and equidistant from outer edges of the rear panel.

5. The gusseted bag of claim 4 wherein the rear flap cuts are near but not at the outer edges of the rear panel.

6. The gusseted bag of claim 5 wherein the bottom further comprises a display area defined by the rear flap fold line, the bottom edge of the rear panel, and the rear flap cuts.

7. The gusseted bag of claim 1, wherein the gusset overlap region comprises a heat seal between the at least partially overlapped gussets.

8. The gusseted bag of claim 1 wherein the bag further comprises a top end, wherein the top end comprises a cut pattern selected from the group consisting of a Z cut, a flush cut, and a step cut.

9. The gusseted bag of claim 1 wherein the bag is constructed of an effectively single ply plastic laminate comprising a layer of woven plastic laminated to a layer of plastic film.

10. The gusseted bag of claim 9, wherein the woven plastic is woven oriented polypropylene and the plastic film is reverse-printed plastic.

11. A gusseted bag comprising a front panel and rear panel joined by a pair gussets, the front panel, rear panel, and gussets each having respective bottom edges,
wherein the gussets are inwardly folded along gusset bottom fold lines to at least partially overlap and create a gusset overlap region,
the bag further comprising a front flap and a rear flap, wherein the front flap is a portion of the folded gussets and the front panel beyond a front flap fold line, and wherein the rear flap is a portion of the gussets and the rear panel beyond a rear flap fold line,
the rear flap comprising two rear flap cuts on the bottom edge of the rear panel, where the rear flap cuts are parallel and of equal length, and equidistant from outer edges of the rear panel, and run from the bottom edge of the rear panel towards the rear flap fold line, wherein the distance between the bottom edge of the rear panel and the rear flap fold line is greater than the length of the rear flap cuts,
wherein the front flap is folded about the front flap fold line onto the inwardly folded gussets, and wherein the rear flap is folded about the rear flap fold line onto the inwardly folded gussets and rear flap,
the bag further comprising a rectangular bottom comprising the front flap, the rear flap, and the inwardly folded gussets,
wherein the gusseted bag is constructed of an effectively single ply plastic laminate comprising a layer of woven plastic laminated to a layer of plastic film.

12. The gusseted bag of claim 11, wherein the front flap is sealed to the inwardly folded gussets at a first seal region, the first seal region being on the front flap parallel to and in proximity to the front flap fold line,
and wherein the rear flap is sealed to the inwardly folded gussets and front flap at a second seal region and a third seal region, the second seal region being on the rear flap parallel to and in proximity to the rear flap fold line, and the third seal region running the length of the bottom edge of the rear panel.

13. The gusseted bag of claim 12 wherein the front flap is sealed to the inwardly folded gussets at a first seal region via selective hot air sealing, and wherein the rear flap is sealed to the inwardly folded gussets and front flap at a second seal region and a third seal region via selective hot air sealing.

14. A method of manufacturing a gusseted bag comprising the steps of
first providing a gusseted tube of material of indefinite length, the tube comprising a front panel and a back panel joined by two gussets and having an interior cavity and a top and a bottom, wherein the front panel, rear panel, and gussets each has respective bottom edges at the bottom of the tube, and
in a second step, cutting the bottom edge of the front panel to create two parallel front flap cuts of equal length which are equidistant from outer edges of the front panel and near the center of the width of the panel, and cutting the bottom edge of the rear panel to create two parallel rear flap cuts of equal length which are equidistant from and near the outer edges of the rear panel, and
in a third step, inwardly folding the gussets at the bottom of the tube along respective gusset bottom fold lines such that the gussets at least partially overlap to create a gusset overlap region,
in a fourth step, removing a front flap trim region at the bottom edge of the front panel,
in a fifth step, where the tube further comprises a front flap, wherein the front flap is a portion of the folded gussets and the front panel beyond a front flap fold line, folding the front flap about the front flap fold line onto the inwardly folded gussets and sealing the front flap thereto,
in a sixth step, removing a rear flap trim region at the bottom edge of the rear panel,
in a seventh step, where the tube further comprises a rear flap, wherein the rear flap is a portion of the gussets and the rear panel beyond a rear flap fold line, folding the rear flap about the rear flap fold line onto the inwardly folded gussets and rear flap and sealing the rear flap thereto.

15. The method of claim 14, wherein the front flap is sealed to the inwardly folded gussets at a first seal region, the first seal region being on the front flap parallel to and in proximity to the front flap fold line,
and wherein the rear flap is sealed to the inwardly folded gussets and front flap at a second seal region and a third seal region, the second seal region being on the rear flap parallel to and in proximity to the rear flap fold line, and the third seal region running the length of the bottom edge of the rear panel.

16. The method of claim 15 wherein the front flap is sealed to the inwardly folded gussets at a first seal region via selective hot air sealing, and wherein the rear flap is sealed to the inwardly folded gussets and front flap at a second seal region and a third seal region via selective hot air sealing.

17. The method of claim 14 further comprising the step of cutting a pattern on the top of the bag, wherein the pattern is selected from the group consisting of a Z cut, a flush cut, and a step cut.

18. The method of claim 14, wherein removing the front flap trim region is achieved via a method selected from the group consisting of cutting the front flap trim region along a front flap trim line and folding the front flap trim region about the front flap trim line, and
wherein removing the rear flap trim region is achieved via a method selected from the group consisting of cutting the rear flap trim region along a rear flap trim line and folding the rear flap trim region about the rear flap trim line.

19. The method of claim 14, wherein the third step further comprises a heat seal between the at least partially overlapped gusseted at the a gusset overlap region.

20. The method of claim 14 wherein the material is an effectively single ply plastic laminate comprising a layer of woven plastic laminated to a layer of plastic film.
